(19) United States
(12) Patent Application Publication
(10) Pub. No.: US 2004/0240622 A1
(43) Pub. Date: Dec. 2, 2004

(54) Radiographic imaging assembly for mammography

(75) Inventors: David J. Steklenski, Rochester, NY (US); James H. Griggs, Rochester, NY (US)

Correspondence Address: Paul A. Leipold, Patent Legal Staff, Eastman Kodak Company, 343 State Street, Rochester, NY, 14650-2201, US

(73) Assignee: Eastman Kodak Company

(21) Appl. No.: 10/449,644

(22) Filed: May 30, 2003

(51) Int. Cl. G03B 42/02

(52) U.S. Cl. 378/171

(57) ABSTRACT

A radiographic imaging assembly comprises a radiographic silver halide film and a single fluorescent intensifying screen that has protective overcoat that comprises a miscible blend of a first polymer that is poly(vinylidene fluoride-co-tetrafluoroethylene) and a second polymer that is a poly(alkyl acrylate or methacrylate). This imaging assembly is particularly useful for mammography or imaging or other soft tissues.

### FIELD OF THE INVENTION

This invention is directed to radiography. In particular, it is directed to a radiographic imaging assembly containing a radiographic silver halide film and a single fluorescent intensifying (prompt-emitting) screen that provides improved medical diagnostic images of soft tissues such as in mammography.

### BACKGROUND OF THE INVENTION

The use of radiation-sensitive silver halide emulsions for medical diagnostic imaging can be traced to Roentgen's discovery of X-radiation by the inadvertent exposure of a silver halide film. Eastman Kodak Company then introduced its first product specifically that was intended to be exposed by X-radiation in 1913.

In conventional medical diagnostic imaging the object is to obtain an image of a patient's internal anatomy with as little X-radiation exposure as possible. The fastest imaging speeds are realized by mounting a dual-coated radiographic element between a pair of fluorescent intensifying screens for imagewise exposure. About 5% or less of the exposing X-radiation passing through the patient is adsorbed directly by the latent image forming silver halide emulsion layers within the dual-coated radiographic element. Most of the X-radiation that participates in image formation is absorbed by phosphor particles within the fluorescent screens. This stimulates light emission that is more readily absorbed by the silver halide emulsion layers of the radiographic element.

Examples of radiographic element constructions for medical diagnostic purposes are provided by U.S. Pat. No. 4,425,425 (Abbott et al.) and U.S. Pat. No. 4,425,426 (Abbott et al.), U.S. Pat. No. 4,414,310 (Dickerson), U.S. Pat. No. 4,803,150 (Dickerson et al.), U.S. Pat. No. 4,900,652 (Dickerson et al.), U.S. Pat. No. 5,252,442 (Tsaur et al.), and Research Disclosure, Vol. 184, August 1979, Item 18431.

While the necessity of limiting patient exposure to high levels of X-radiation was quickly appreciated, the question of patient exposure to even low levels of X-radiation emerged gradually. The separate development of soft tissue radiography, which requires much lower levels of X-radiation, can be illustrated by mammography. The first intensifying screen-film combination (imaging assembly) for mammography was introduced to the public in the early 1970's. Mammography film generally contains a single silver halide emulsion layer and is exposed by a single intensifying screen, usually interposed between the film and the source of X-radiation. Mammography utilizes low energy X-radiation, that is radiation that is predominantly of an energy level less than 40 keV.

U.S. Pat. No. 6,033,840 (Dickerson) and U.S. Pat. No. 6,037,112 (Dickerson) describe asymmetric imaging elements and processing methods for imaging soft tissue.

Problem to be Solved

In mammography, as in many forms of soft tissue radiography, pathological features to be identified are often quite small and not much different in density than surrounding healthy tissue. Thus, relatively high average contrast, in the range of from 2.5 to 3.5, over a density range of from 0.25 to 2.0 is typical. Limiting X-radiation energy levels increases the absorption of the X-radiation by the intensifying screen and minimizes X-radiation exposure of the film, which can contribute to loss of image sharpness and contrast. Thus mammography is a very difficult task in medical radiography. In addition, microcalcifications must be seen when they are as small as possible to improve detection and treatment of breast cancers. As a result, there is desire to improve the image quality of mammography films. Improvements in image quality in imaging assemblies can be achieved by increasing the signal (that is, contrast) and modulating transfer function (MTF) and/or decreasing noise (reducing film/granularity and lowering quantum mottle).

Improved radiographic films for mammography have been developed that reduce stain from spectral sensitizing dyes in radiographic films. In some instances, dye stain is reduced by incorporating unique spectral sensitizing dyes that are more readily washed out of the films during processing. However, such spectral sensitizing dyes may be highly water-soluble and tend to leach out of the films and contaminate any fluorescent intensifying screen that is in contact with them. There is a need to protect such screens from residual spectral sensitizing dye.

U.S. Pat. No. 5,401,971 (Roberts) describes storage panels that comprise a protective overcoat composed of a unique blend of polymers. This overcoat layer is believed to stabilize the panel against discoloration associated with iodide-containing phosphors. Thus, the protective overcoat appears to solve a problem that may be within the storage panel itself rather than a problem that originates from an external source.

Fluorescent intensifying screens used in mammography have very stringent requirements for speed and image resolution. Since mammography uses a single screen in the imaging assembly, the cleanliness of the screen surface is of high importance. The accumulation of the smallest amount of dirt or debris is inevitable but highly detrimental to image quality. Thus, the screens are cleaned frequently with cleaning solutions that are designed to have minimal abrasive properties. However, even the best screen cleaners eventually wear away or scratch the screen surface. It addition, movement of the film against the screen as the film is moved in and out of the cassette can cause wear on the screen surfaces.

Efforts have been underway to design screens with highly durable protective coatings that will not decrease image quality. Thus, suitable screen overcoats must have a high degree of abrasion resistance, be very hydrophobic to prevent penetration of film components into the phosphor layer during cleaning, be resistant to staining, and must allow air to escape between the film-screen interface. The present invention is directed to solving these problems.

### SUMMARY OF THE INVENTION

This invention provides a radiographic imaging assembly comprising:

A) a single radiographic silver halide film comprising a support having first and second major surfaces and that is capable of transmitting X-radiation,

the radiographic silver halide film having disposed on the first major support surface, one or more hydrophilic colloid layers including at least one silver halide emulsion layer, and on the second major support surface, one or more hydrophilic colloid layers including at least one silver halide emulsion layer,

at least one of the silver halide emulsion layers comprising cubic silver halide grains that have the same or different composition, and

B) a single fluorescent intensifying screen that comprises an inorganic phosphor capable of absorbing X-rays and emitting electromagnetic radiation having a wavelength greater than 300 nm, the inorganic phosphor being coated in admixture with a polymeric binder in a phosphor layer onto a flexible support and having a protective overcoat disposed over the phosphor layer,

the protective overcoat comprising a miscible blend of a first polymer that is poly(vinylidene fluoride-co-tetrafluoroethylene) and a second polymer that is a poly(alkyl acrylate or methacrylate).

In preferred embodiments, the radiographic imaging assembly of this invention comprises a radiographic silver halide film wherein each cubic grain silver halide emulsion layer comprises:

1) a combination of first and second spectral sensitizing dyes that provides a combined maximum J-aggregate absorption on the cubic silver halide grains of from about 540 to about 560 nm, and

wherein the first spectral sensitizing dye is an anionic benzimidazole-benzoxazole carbocyanine, the second spectral sensitizing dye is an anionic oxycarbocyanine, and the first and second spectral sensitizing dyes are present in a molar ratio of from about 0.25:1 to about 4:1,

2) a mixture of a first hydrophilic binder that is gelatin or a gelatin derivative and a second hydrophilic binder other than gelatin or a gelatin derivative, wherein the weight ratio of the first hydrophilic binder to the second hydrophilic binder is from about 2:1 to about 5:1, and the level of hardener in the cubic grain silver halide emulsion layer is from about 0.4 to about 1.5 weight % based on the total weight of the first hydrophilic binder in the cubic grain silver halide emulsion layer,

3) cubic silver halide grains comprising from about 1 to about 20 mol % chloride and from about 0.25 to about 1.5 mol % iodide, both based on total silver in the cubic grain emulsion layer, which cubic silver halide grains have an average ECD of from about 0.65 to about 0.8 μm, and

4) cubic silver halide grains that are doped with a hexacoordination complex compound within part or all of 95% of the innermost volume from the center of the cubic silver halide grains.

This invention also provides a method of providing a black-and-white image comprising exposing the radiographic imaging assembly of the invention, and processing the radiographic silver halide film, sequentially, with a black-and-white developing composition and a fixing composition, the processing being carried out within 90 seconds, dry-to-dry. The resulting image can be used, for example, for medical diagnosis.

In addition, a method of imaging for mammography comprises exposing a patient to X-radiation using an X-radiation generating device comprising rhodium or tungsten anodes, and providing a black-and-white image of the exposed patient using an imaging assembly of this invention.

The present invention provides a radiographic imaging assembly that provide highquality images in mammography. Moreover, the fluorescent intensifying (prompt-emitting) screens used in the imaging assembly are protected from residual spectral sensitizing dye that may leach out of the radiographic silver halide film, are highly abrasion resistant, easily cleaned, and suitable for allowing the film to slide in and out of cassettes.

These advantages are achieved by using a novel combination of a radiographic film and a single fluorescent intensifying screen that has a special protective overcoat composition. This protective overcoat comprises a miscible blend of polymers that provides physical protection of the screen from scratches and debris while prohibiting stain or contamination from spectral sensitizing dyes that may leach out of the radiographic films.

### DETAILED DESCRIPTION OF THE INVENTION

Definitions:

The term “contrast” as herein employed indicates the average contrast derived from a characteristic curve of a radiographic film using as a first reference point (1) a density (D₁) of 0.25 above minimum density and as a second reference point (2) a density (D₂) of 2.0 above minimum density, where contrast is ΔD (i.e. 1.75)÷Δ log₁₀ E (log₁₀ E2−log₁₀ E₁), E₁ and E₂ being the exposure levels at the reference points (1) and (2).

“Gamma” is described as the instantaneous rate of change of a D log E sensitometric curve or the instantaneous contrast at any log E value.

“Photographic speed” (or sensitivity) for the radiographic silver halide films refers to the exposure necessary to obtain a density of at least 1.0 plus Dₘᵢₙ.

“Photographic speed” for the fluorescent intensifying screens refers to the percentage photicity relative to a conventional KODAK MinR fluorescent intensifying screen.

“Photicity” is the integral from the minimum wavelength of the light emitted by the screen to the maximum wavelength of the intensity of light emitted by the screen divided by the sensitivity of the recording medium (film). This is shown by the following equation where I(λ) is the intensity of the light emitted by the screen at wavelength λ and S(λ) is the sensitivity of the film at wavelength λ. S(λ) is in units of ergs/cm² required to reach a density of 1.0 above base plus fog.

$$Photicity = {\int }_{λmin}^{λmax} \frac{I ( λ )}{S ( λ )} ⅆ λ$$

The term “fully forehardened” is employed to indicate the forehardening of hydrophilic colloid layers to a level that limits the weight gain of a radiographic film to less than 120% of its original (dry) weight in the course of wet processing. The weight gain is almost entirely attributable to the ingestion of water during such processing.

The term “rapid access processing” is employed to indicate dry-to-dry processing of a radiographic film in 45 seconds or less. That is, 45 seconds or less elapse from the time a dry imagewise exposed radiographic film enters a wet processor until it emerges as a dry fully processed film.

In referring to grains and silver halide emulsions containing two or more halides, the halides are named in order of ascending molar concentrations.

The term “equivalent circular diameter” (ECD) is used to define the diameter of a circle having the same projected area as a silver halide grain.

The term “aspect ratio” is used to define the ratio of grain ECD to grain thickness.

The term “coefficient of variation” (COV) is defined as 100 times the standard deviation (a) of grain ECD divided by the mean grain ECD.

The term “covering power” is used to indicate 100 times the ratio of maximum density to developed silver measured in mg/dm².

The term “dual-coated” is used to define a radiographic silver halide film having silver halide emulsion layers disposed on both the front- and backsides of the support. The radiographic silver halide films used in the present invention are “dual-coated.”

The term “exposure latitude” refers to the width of the gamma/log E curves for which contrast values were greater than 1.5.

The term “dynamic range” refers to the range of exposures over which useful images can be obtained (usually having a gamma greater than 2).

The terms “kVp” and “MVp” stand for peak voltage applied to an X-ray tube times 10³ and 10⁶, respectively.

The term “fluorescent intensifying screen” refers to a “prompt-emitting” screen that absorbs X-radiation and immediately emits light upon exposure. Thus, the screens used in the present invention are not “storage” fluorescent screens that can “store” the exposing X-radiation for emission at a later time when the screen is irradiated with other radiation (usually visible light).

The terms “front” and “back” refer to layers, films, or fluorescent intensifying screens nearer to and farther from, respectively, the source of X-radiation.

The term “rare earth” is used to indicate chemical elements having an atomic number of 39 or 57 through 71.

Research Disclosure is published by Kenneth Mason Publications, Ltd., Dudley House, 12 North St., Emsworth, Hampshire P010 7DQ England. This publication is also available from Emsworth Design Inc., 147 West 24th Street, New York, N.Y. 10011.

Radiographic Films:

The radiographic silver halide films useful in this invention include a flexible support having disposed on both sides thereof, one or more photographic silver halide emulsion layers and optionally one or more non-radiation sensitive hydrophilic layer(s). The silver halide emulsions in the various layers can be the same or different and can comprise mixtures of various silver halide emulsions as long as one silver halide emulsion layer on each side comprises cubic silver halide grains.

In preferred embodiments, the photographic silver halide film has the same silver halide cubic grain emulsions on both sides of the support. It is also preferred that the film has a protective overcoat (described below) over the silver halide emulsions on each side of the support.

The support can take the form of any conventional radiographic film support that is X-radiation and light transmissive. Useful supports for the films of this invention can be chosen from among those described in Research Disclosure, September 1996, Item 38957 XV. Supports and Research Disclosure, Vol. 184, August 1979, Item 18431, XII. Film Supports.

The support is preferably a transparent film support. In its simplest possible form the transparent film support consists of a transparent film chosen to allow direct adhesion of the hydrophilic silver halide emulsion layers or other hydrophilic layers. More commonly, the transparent film is itself hydrophobic and subbing layers are coated on the film to facilitate adhesion of the hydrophilic silver halide emulsion layers. Typically the film support is either colorless or blue tinted (tinting dye being present in one or both of the support film and the subbing layers). Referring to Research Disclosure, Item 38957, Section XV Supports, cited above, attention is directed particularly to paragraph (2) that describes subbing layers, and paragraph (7) that describes preferred polyester film supports.

Polyethylene terephthalate and polyethylene naphthalate are the preferred transparent film support materials.

In the more preferred embodiments, at least one non-light sensitive hydrophilic layer is included with the one or more silver halide emulsion layers on each side of the film support. This layer may be called an interlayer or overcoat, or both.

The silver halide grains useful in this invention can have any desirable morphology including, but not limited to, cubic, octahedral, tetradecahedral, rounded, spherical or other non-tabular morphologies, or be comprised of a mixture of two or more of such morphologies. Preferably, the grains in each silver halide emulsion have cubic morphology.

Preferably, the “frontside” of the support comprises one or more silver halide emulsion layers, one of which contains predominantly cubic grains (that is, more than 50 weight % of all grains). The cubic silver halide grains particularly include predominantly (at least 70 mol %) bromide, and preferably at least 90 mol % bromide, based on total silver in the emulsion layer. In addition, these cubic grains can have up to 1 mol % iodide, and/or up to 15 mol % chloride, based on total silver in the emulsion layer. The cubic silver halide grains in each silver halide emulsion unit (or silver halide emulsion layers) can be the same or different, or mixtures of different types of cubic grains.

In more preferred embodiments, the cubic silver halide grains include predominantly (at least 78.5 mol %) bromide, and up to 98.75 mol % bromide, based on total silver in the cubic grain silver halide emulsion layer. In addition, these cubic grains have from about 1 to about 20 mol % chloride (preferably from about 10 to about 20 mol % chloride) and from about 0.25 to about 1.5 mol % iodide (preferably from about 0.5 to about 1 mol % iodide), based on total silver in this cubic grain emulsion layer.

The average silver halide grain size (ECD) can vary within each radiographic silver halide film and within each emulsion layer within that film. For example, the average cubic grain size in each radiographic silver halide film is independently and generally from about 0.7 to about 0.9 μm (preferably from about 0.75 to about 0.85 μm), but the average grain size can be different in the various emulsion layers.

The non-cubic silver halide grains in the “frontside” emulsion layers can have any desirable morphology including, but not limited to, octahedral, tetradecahedral, rounded, spherical or other non-tabular morphologies, or be comprised of a mixture of two or more of such morphologies.

It may also be desirable to employ silver halide grains that exhibit a coefficient of variation (COV) of grain ECD of less than 20% and, preferably, less than 10%. In some embodiments, it may be desirable to employ a grain population that is as highly monodisperse as can be conveniently realized.

The emulsions used in the radiographic silver halide films can be doped with any of conventional dopants to increase the contrast. Mixtures of dopants can be used also. Particularly useful dopants are hexacoordination complexes of Group 8 transition metals such as ruthenium. Preferably, only the cubic grains on the frontside of the film are doped with hexacoordination complex compounds. The term “dopant” is well known in photographic chemistry and generally refers to a compound that includes a metal ion that displaces silver in the crystal lattice of the silver halide grain, exhibits a positive valence of from 2 to 5, and has its highest energy electron occupied molecular orbital filled and its lowest energy unoccupied molecular orbital at an energy level higher than the lowest energy conduction band of the silver halide crystal lattice forming the protrusions.

The hexacoordination complex compounds particularly useful are represented by the following Structure DOPANT:

[ML₆]^{n′} (DOPANT)

wherein M is a Group VIII polyvalent transition metal ion, L represents six coordination complex ligands that can be the same or different provided that at least four of the ligands are anionic ligands and at least one (preferably at least 3) of the ligands is more electronegative than any halide ligand, and n′ is −2, −3, or −4. Preferably, n′ is −3 or −4.

Examples of M include but are not limited to, Fe⁺², Ru⁺², Os⁺², Co⁺³, Rh⁺³, Ir⁺³, Pd⁺³, and Pt⁺⁴, and preferably M is Ru⁺². Examples of useful coordination complex ligands include but are not limited to, cyanide, pyrazine, chloride, iodide, bromide, oxycyanide, water, oxalate, thiocyanide, and carbon monoxide. Cyanide is a preferred coordination complex ligand.

Particularly useful dopants are ruthenium coordination complexes comprising at least 4 and more preferably 6 cyanide coordination complex ligands.

Mixtures of dopants described above can also be used.

The metal dopants can be introduced during emulsion precipitation using procedures well known in the art. They can be present in the dispersing medium present in the reaction vessel before grain nucleation. More typically, the metal coordination complexes are introduced at least in part during precipitation through one of the halide ion or silver ion jets or through a separate jet. Such procedures are described in U.S. Pat. No. 4,933,272 (McDugle et al.) and U.S. Pat. No. 5,360,712 (Olm et al.), both incorporated herein by reference.

While some dopants in the art are distributed uniformly throughout 100% of the volume of the silver halide grains, it may be desired to provide the dopant in only a part of the grain volume, generally within 95% and preferably within 90% of the innermost volume from the center of the cubic silver halide grains. Methods for doing this are known in the art, for example is described in U.S. Pat. No. 4,933,272 and U.S. Pat. No. 5,360,712 (both noted above).

In other embodiments, the dopants are uniformly distributed in “bands” of the silver halide grains, for example, within a band that is from about 50 to about 80 innermost volume % (preferably from about 75 to about 80 innermost volume % for ruthenium hexacoordinating complex compounds) from the center or core of the cubic silver halide grains. One skilled in the art would readily know how to achieve these results by planned addition of the doping compounds during only a portion of the process used to prepare the silver halide.

It is also desired that the one or more dopants be present within the cubic grains in an amount of at least 1×10⁻⁶ mole, preferably from about 1×10⁻⁶ to about 5×10⁻⁴ mole, and more preferably from about 1×10⁻⁵ to about 5×10⁻⁴ mole, per mole of silver in the cubic grain emulsion layer.

The backside of the support also includes one or more silver halide emulsion layers, preferably at least one of which comprises tabular silver halide grains. Generally, at least 50% (and preferably at least 80%) of the silver halide grain projected area in this silver halide emulsion layer is provided by tabular grains having an average aspect ratio greater than 5, and more preferably greater than 10. The remainder of the silver halide projected area is provided by silver halide grains having one or more non-tabular morphologies. In addition, the tabular grains are predominantly (at least 90 mol %) bromide based on the total silver in the emulsion layer and can include up to 1 mol % iodide. Preferably, the tabular grains are pure silver bromide.

Tabular grain emulsions that have the desired composition and sizes are described in greater detail in the following patents, the disclosures of which are incorporated herein by reference:

U.S. Pat. No. 4,414,310 (Dickerson), U.S. Pat. No. 4,425,425 (Abbott et al.), U.S. Pat. No. 4,425,426 (Abbott et al.), U.S. Pat. No. 4,439,520 (Kofron et al.), U.S. Pat. No. 4,434,226 (Wilgus et al.), U.S. Pat. No. 4,435,501 (Maskasky), U.S. Pat. No. 4,713,320 (Maskasky), U.S. Pat. No. 4,803,150 (Dickerson et al.), U.S. Pat. No. 4,900,355 (Dickerson et al.), U.S. Pat. No. 4,994,355 (Dickerson et al.), U.S. Pat. No. 4,997,750 (Dickerson et al.), U.S. Pat. No. 5,021,327 (Bunch et al.), U.S. Pat. No. 5,147,771 (Tsaur et al.), U.S. Pat. No. 5,147,772 (Tsaur et al.), U.S. Pat. No. 5,147,773 (Tsaur et al.), U.S. Pat. No. 5,171,659 (Tsaur et al.), U.S. Pat. No. 5,252,442 (Dickerson et al.), U.S. Pat. No. 5,370,977 (Zietlow), U.S. Pat. No. 5,391,469 (Dickerson), U.S. Pat. No. 5,399,470 (Dickerson et al.), U.S. Pat. No. 5,411,853 (Maskasky), U.S. Pat. No. 5,418,125 (Maskasky), U.S. Pat. No. 5,494,789 (Daubendiek et al.), U.S. Pat. No. 5,503,970 (Olm et al.), U.S. Pat. No. 5,536,632 (Wen et al.), U.S. Pat. No. 5,518,872 (King et al.), U.S. Pat. No. 5,567,580 (Fenton et al.), U.S. Pat. No. 5,573,902 (Daubendiek et al.), U.S. Pat. No. 5,576,156 (Dickerson), U.S. Pat. No. 5,576,168 (Daubendiek et al.), U.S. Pat. No. 5,576,171 (Olm et al.), and U.S. Pat. No. 5,582,965 (Deaton et al.). The patents to Abbott et al., Fenton et al., Dickerson, and Dickerson et al. are also cited and incorporated herein to show conventional radiographic film features in addition to gelatino-vehicle, high bromide (≧80 mol % bromide based on total silver) tabular grain emulsions and other features useful in the present invention.

The backside (“second major support surface”) of the radiographic silver halide film also preferably includes an antihalation layer disposed over the silver halide emulsion layer(s). This layer comprises one or more antihalation dyes or pigments dispersed on a suitable hydrophilic binder (described below). In general, such antihalation dyes or pigments are chosen to absorb whatever radiation the film is likely to be exposed to from a fluorescent intensifying screen. For example, pigments and dyes that can be used as antihalation pigments or dyes include various water-soluble, liquid crystalline, or particulate magenta or yellow filter dyes or pigments including those described for example in U.S. Pat. No. 4,803,150 (Dickerson et al.), U.S. Pat. No. 5,213,956 (Diehl et al.), U.S. Pat. No. 5,399,690 (Diehl et al.), U.S. Pat. No. 5,922,523 (Helber et al.), U.S. Pat. No. 6,214,499 (Helber et al.), and Japanese Kokai 2-123349, all of which are incorporated herein by reference for pigments and dyes useful in the practice of this invention. One useful class of particulate antihalation dyes includes nonionic polymethine dyes such as merocyanine, oxonol, hemioxonol, styryl, and arylidene dyes as described in U.S. Pat. No. 4,803,150 (noted above) that is incorporated herein for the definitions of those dyes. The magenta merocyanine and oxonol dyes are preferred and the oxonol dyes are most preferred.

The amounts of such dyes or pigments in the antihalation layer are generally from about 1 to about 2 mg/dm². A particularly useful antihalation dye is the magenta filter dye M-1 identified as follows:

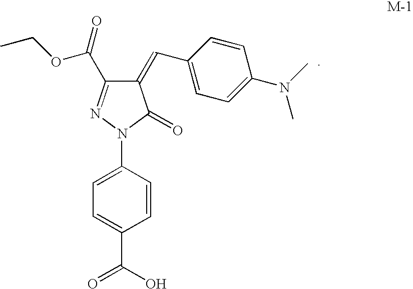

A general summary of silver halide emulsions and their preparation is provided by Research Disclosure, Item 38957, cited above, Section I. Emulsion grains and their preparation. After precipitation and before chemical sensitization the emulsions can be washed by any convenient conventional technique using techniques disclosed by Research Disclosure, Item 38957, cited above, Section III. Emulsion washing.

The emulsions can be chemically sensitized by any convenient conventional technique as illustrated by Research Disclosure, Item 38957, Section IV. Chemical Sensitization: Sulfur, selenium or gold sensitization (or any combination thereof) are specifically contemplated. Sulfur sensitization is preferred, and can be carried out using for example, thiosulfates, thiosulfonates, thiocyanates, isothiocyanates, thioethers, thioureas, cysteine or rhodanine. A combination of gold and sulfur sensitization is most preferred.

In addition, if desired, the silver halide emulsions can include one or more suitable spectral sensitizing dyes, for example cyanine and merocyanine spectral sensitizing dyes, including the benzimidazolocarbocyanine dyes described in U.S. Pat. No. 5,210,014 (Anderson et al.), incorporated herein by reference. The useful amounts of such dyes are well known in the art but are generally within the range of from about 200 to about 1000 mg/mole of silver in the emulsion layer.

In preferred embodiments, at least one of the cubic grain silver halide emulsion layers comprises a combination of one or more first spectral sensitizing dyes and one or more second spectral sensitizing dyes that provide a combined J-aggregate absorption within the range of from about 540 to about 560 nm (preferably from about 545 to about 555 nm) when absorbed on the cubic silver halide grains. The one or more first spectral sensitizing dyes are anionic benzimidazole-benzoxazole carbocyanines and the one or more second spectral sensitizing dyes are anionic oxycarbocyanines.

More preferably, all cubic grain silver halide emulsions in the film contain one or more of these combinations of spectral sensitizing dyes. The combinations of dyes can be the same of different in each cubic grain silver halide emulsion layer. A most preferred combination of spectral sensitizing dyes A-2 and B-1 identified below has a combined J-aggregate absorption λₘₐₓ of about 552 nm when absorbed to cubic silver halide grains.

The first and second spectral sensitizing dyes can be provided on the cubic silver halide grains in a molar ratio of one or more first spectral sensitizing dyes to one or more second spectral sensitizing dyes of from about 0.25:1 to about 4:1, preferably at a molar ratio of from about 0.5:1 to about 1.5:1, and more preferably at a molar ratio of from about 0.75:1 to about 1.25:1. A most preferred combination of spectral sensitizing dyes A-2 and B-1 identified below is a molar ratio of 1:1. The useful total amounts of the first and second dyes in a given cubic grain silver halide emulsion layer are generally and independently within the range of from about 0.1 to about 1 mmol/mole of silver in the emulsion layer. Optimum amounts will vary with the particular dyes used and a skilled worker in the art would understand how to achieve optimal benefit with the combination of dyes in appropriate amounts. The total amount of both dyes is generally from about 0.25 to about 0.75 mmol/mole of silver.

Preferred “first” spectral sensitizing dyes can be represented by the following Structure I, and preferred “second” spectral sensitizing dyes can be represented by the following Structure II.

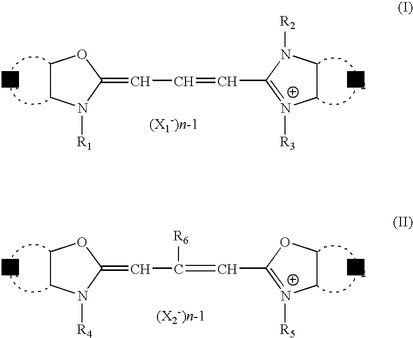

In both Structure I and II, Z₁ and Z₂ are independently the carbon atoms that are necessary to form a substituted or unsubstituted benzene or naphthalene ring. Preferably, each of Z₁ and Z₂ independently represent the carbon atoms necessary to form a substituted or unsubstituted benzene ring.

X₁⁻ and X₂⁻ are independently anions such as halides, thiocyanate, sulfate, perchlorate, p-toluene sulfonate, ethyl sulfate, and other anions readily apparent to one skilled in the art. In addition, “n” is 1 or 2, and it is 1 when the compound is an intermolecular salt.

In Structure I, R₁, R₂, and R₃ are independently alkyl groups having 1 to 10 carbon atoms, alkoxy groups having 1 to 10 carbon atoms, aryl groups having 6 to 10 carbon atoms in the aromatic ring, alkenyl groups having 2 to 8 carbon atoms, and other substituents that would be readily apparent to one skilled in the art. Such groups can be substituted with one or more hydroxy, alkyl, carboxy, sulfo, halo, and alkoxy groups. Preferably, at least one of the R₁, R₂, and R₃ groups comprises at least one sulfo or carboxy group.

Preferably, R₁, R₂, and R₃ are independently alkyl groups having 1 to 4 carbon atoms, phenyl groups, alkoxy groups having 1 to 4 carbon atoms, or alkenyl groups having 2 to 4 carbon atoms. All of these groups can be substituted as described above, and in particular, they can be substituted with a sulfo or carboxy group.

In Structure II, R₄ and R₅ are independently defined as noted above for R₁, R₂, and R₃. R₆ is hydrogen, an alkyl group having 1 to 4 carbon atoms, or a phenyl group, each of which groups can be substituted as described above for the other radicals.

Further details of such spectral sensitizing dyes are provided in U.S. Pat. No. 4,659,654 (Metoki et al.), incorporated herein by reference. These dyes can be readily prepared using known synthetic methods, as described for example in Hamer, Cyanine Dyes and Related Compounds, John Wiley & Sons, 1964, incorporated herein by reference.

Representative “first” spectral sensitizing dyes include the following Compounds A-1 to A-7:

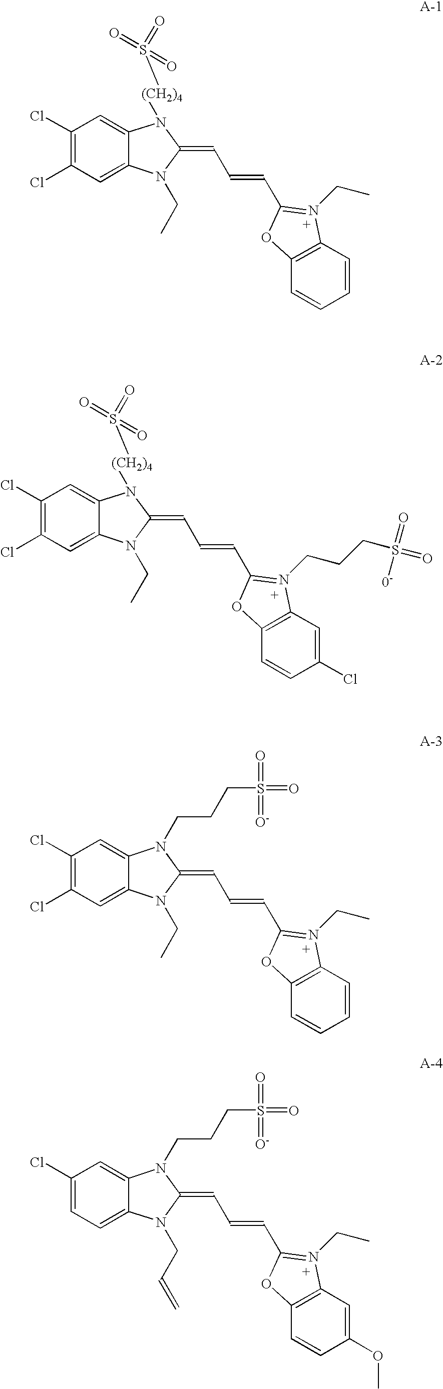

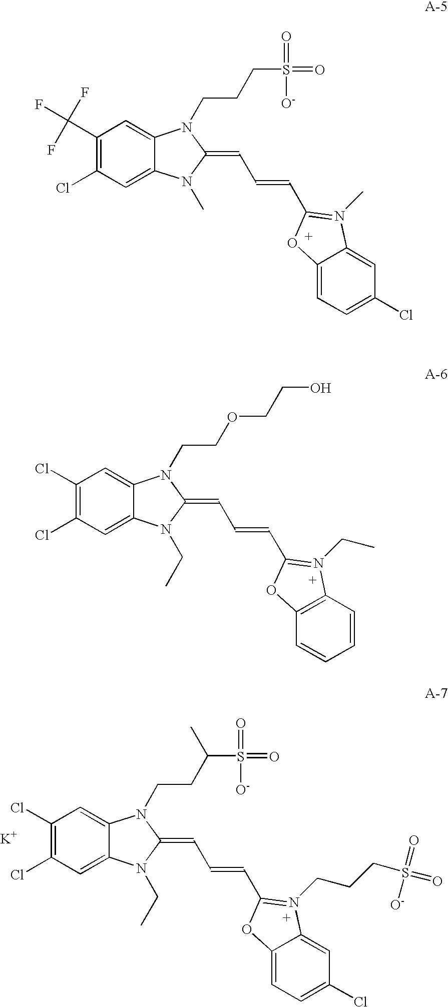

Representative “second” spectral sensitizing dyes include the following Compounds B-1 to B-5:

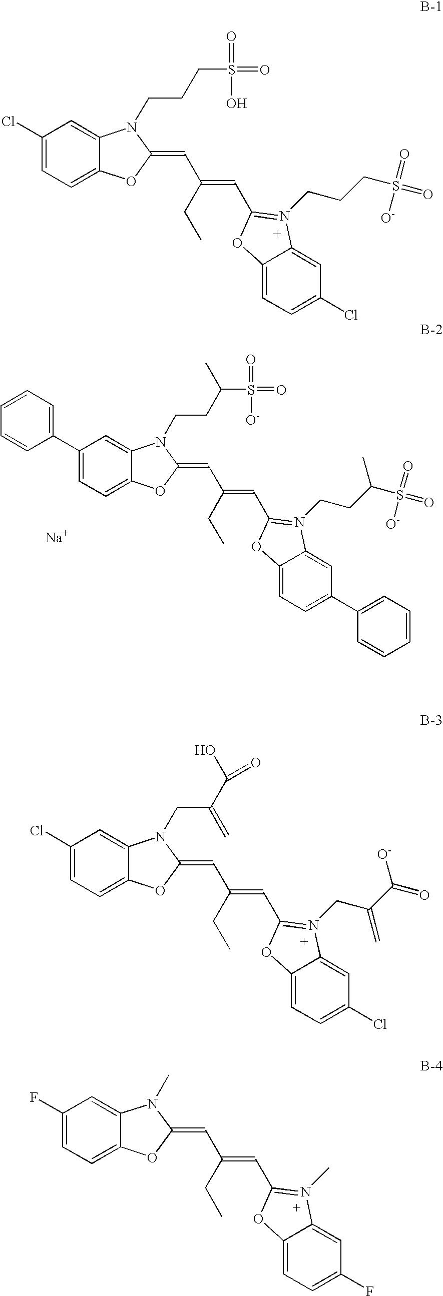

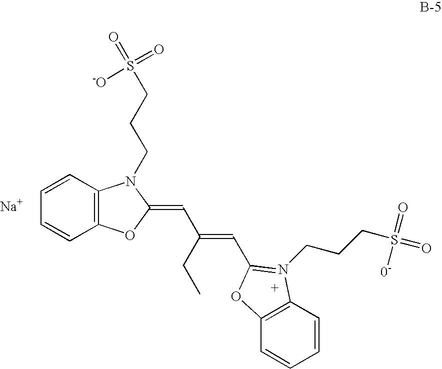

Instability that increases minimum density in negative-type emulsion coatings (that is fog) can be protected against by incorporation of stabilizers, antifoggants, antikinking agents, latent-image stabilizers and similar addenda in the emulsion and contiguous layers prior to coating. Such addenda are illustrated by Research Disclosure, Item 38957, Section VII. Antifoggants and stabilizers, and Item 18431, Section II: Emulsion Stabilizers, Antifoggants and Antikinking Agents.

It may also be desirable that one or more silver halide emulsion layers include one or more covering power enhancing compounds adsorbed to surfaces of the silver halide grains. A number of such materials are known in the art, but preferred covering power enhancing compounds contain at least one divalent sulfur atom that can take the form of a —S— or ═S moiety. Such compounds include, but are not limited to, 5-mercapotetrazoles, dithioxotriazoles, mercapto-substituted tetraazaindenes, and others described in U.S. Pat. No. 5,800,976 (Dickerson et al.) that is incorporated herein by reference for the teaching of the sulfur-containing covering power enhancing compounds.

The silver halide emulsion layers and other hydrophilic layers on both sides of the support of the radiographic films generally contain conventional polymer vehicles (peptizers and binders) that include both synthetically prepared and naturally occurring colloids or polymers. The most preferred polymer vehicles include gelatin or gelatin derivatives alone or in combination with other vehicles. Conventional gelatino-vehicles and related layer features are disclosed in Research Disclosure, Item 38957, Section II. Vehicles, vehicle extenders, vehicle-like addenda and vehicle related addenda. The emulsions themselves can contain peptizers of the type set out in Section II, paragraph A. Gelatin and hydrophilic colloid peptizers. The hydrophilic colloid peptizers are also useful as binders and hence are commonly present in much higher concentrations than required to perform the peptizing function alone. The preferred gelatin vehicles include alkali-treated gelatin, acid-treated gelatin or gelatin derivatives (such as acetylated gelatin, deionized gelatin, oxidized gelatin and phthalated gelatin). Cationic starch used as a peptizer for tabular grains is described in U.S. Pat. No. 5,620,840 (Maskasky) and U.S. Pat. No. 5,667,955 (Maskasky). Both hydrophobic and hydrophilic synthetic polymeric vehicles can be used also. Such materials include, but are not limited to, polyacrylates (including polymethacrylates), polystyrenes and polyacrylamides (including polymethaerylamides). Dextrans can also be used as part or all of the binder materials in an emulsion layer. Examples of such materials are described for example in U.S. Pat. No. 5,876,913 (Dickerson et al.), incorporated herein by reference.

The silver halide emulsion layers (and other hydrophilic layers) in the radiographic films are generally fully hardened using one or more conventional hardeners. Thus, the amount of hardener in each silver halide emulsion and other hydrophilic layer is generally at least 2% and preferably at least 2.5%, based on the total dry weight of the polymer vehicle in each layer.

Conventional hardeners can be used for this purpose, including but not limited to formaldehyde and free dialdehydes such as succinaldehyde and glutaraldehyde, blocked dialdehydes, α-diketones, active esters, sulfonate esters, active halogen compounds, s-triazines and diazines, epoxides, aziridines, active olefins having two or more active bonds, blocked active olefins, carbodiimides, isoxazolium salts unsubstituted in the 3-position, esters of 2-alkoxy-N-carboxydihydroquinoline, N-carbamoyl pyridinium salts, carbamoyl oxypyridinium salts, bis(amidino) ether salts, particularly bis(amidino) ether salts, surface-applied carboxyl-activating hardeners in combination with complex-forming salts, carbamoylonium, carbamoyl pyridinium and carbamoyl oxypyridinium salts in combination with certain aldehyde scavengers, dication ethers, hydroxylamine esters of imidic acid salts and chloroformamidinium salts, hardeners of mixed function such as halogen-substituted aldehyde acids (for example, mucochloric and mucobromic acids), onium-substituted acroleins, vinyl sulfones containing other hardening functional groups, polymeric hardeners such as dialdehyde starches, and poly(acrolein-co-methacrylic acid).

Another preferred feature of the radiographic silver halide films is the presence of a mixture of hydrophilic binders in at least one of the cubic silver halide grain emulsions on the frontside of the films of this invention. This mixture of hydrophilic binders includes gelatin or a gelatin derivative (as defined above) as a “first” binder (or a mixture of gelatin and gelatin derivatives), and a “second” hydrophilic binder (or mixture thereof) that is not gelatin or a gelatin derivative. Preferably, this mixture of binders is present in the frontside cubic grain silver halide emulsion layer that also includes the mixture of first and second spectral sensitizing dyes, the hexacoordination complex compounds as dopants, and the unique combination of silver bromide, silver iodide, and silver chloride in the cubic grains described above.

Useful “second” hydrophilic binders include, but are not limited to, polyacrylates (including polymethacrylates), polystyrenes and poly(acrylamides) [including poly(methacrylamides)], dextrans, and various polysaccharides. Examples of such materials are described for example in U.S. Pat. No. 5,876,913 (Dickerson et al.), incorporated herein by reference. The dextrans are preferred.

The weight ratio of first hydrophilic binder (or mixture thereof) to second hydrophilic binder (or mixture thereof) in the cubic grain silver halide emulsion layer is from about 2:1 to about 5:1. Preferably, this weight ratio is from about 2.5:1 to about 3.5:1. A most preferred weight ratio is about 3:1.

The cubic grain silver halide emulsion layers in the radiographic silver halide films are generally hardened to various degrees using one or more conventional hardeners. Conventional hardeners can be used for this purpose, including but not limited to those described above.

The cubic grain silver halide emulsion layer comprising the mixture of first and second binders includes a critical amount of one or more hardeners that is at least 0.4 weight % based on the total binder weight in that emulsion layer. Preferably, the amount of hardener in that emulsion layer is from about 0.5 to about 1.5 weight % and a most preferred amount is about 1 weight %. While any of the noted conventional hardeners can be used, the preferred hardeners include bisvinylsulfonylmethylether and bisvinylsulfonylmethane.

The levels of silver and polymer vehicle in the radiographic silver halide film used in the present invention are not critical. In general, the total amount of silver on each side of each film is at least 10 and no more than 55 mg/dm² in one or more emulsion layers. In addition, the total amount of polymer vehicle on each side of each film is generally at least 35 and no more than 45 mg/dm² in one or more hydrophilic layers. The amounts of silver and polymer vehicle on the two sides of the support in the radiographic silver halide film can be the same or different. Preferably, the amounts are different. These amounts refer to dry weights.

The radiographic silver halide films useful in this invention generally include a surface protective overcoat on each side of the support that typically provides physical protection of the emulsion layers. Each protective overcoat can be sub-divided into two or more individual layers. For example, protective overcoats can be sub-divided into surface overcoats and interlayers (between the overcoat and silver halide emulsion layers). In addition to vehicle features discussed above the protective overcoats can contain various addenda to modify the physical properties of the overcoats. Such addenda are illustrated by Research Disclosure, Item 38957, Section IX. Coating physical property modifying addenda, A. Coating aids, B. Plasticizers and lubricants, C. Antistats, and D. Matting agents. Interlayers that are typically thin hydrophilic colloid layers can be used to provide a separation between the emulsion layers and the surface overcoats. The overcoat on at least one side of the support can also include a blue toning dye or a tetraazaindene (such as 4-hydroxy-6-methyl-1,3,3a,7-tetraazaindene) if desired.

The protective overcoat is generally comprised of one or more hydrophilic colloid vehicles, chosen from among the same types disclosed above in connection with the emulsion layers. Protective overcoats are provided to perform two basic functions. They provide a layer between the emulsion layers and the surface of the film for physical protection of the emulsion layer during handling and processing. Secondly, they provide a convenient location for the placement of addenda, particularly those that are intended to modify the physical properties of the radiographic film. The protective overcoats of the films of this invention can perform both these basic functions.

The various coated layers of radiographic silver halide films used in this invention can also contain tinting dyes to modify the image tone to transmitted or reflected light. These dyes are not decolorized during processing and may be homogeneously or heterogeneously dispersed in the various layers. Preferably, such non-bleachable tinting dyes are in a silver halide emulsion layer.

Radiographic Imaging Assembly:

The radiographic imaging assemblies of the present invention are composed of one radiographic silver halide film as described herein and a single fluorescent intensifying screen that generally has a photographic speed of at least 100. Fluorescent intensifying screens are typically designed to absorb X-rays and to emit electromagnetic radiation having a wavelength greater than 300 nm. These screens can take any convenient form providing they meet all of the usual requirements for use in radiographic imaging. Examples of conventional, useful fluorescent intensifying screens and methods of making them are provided by Research Disclosure, Item 18431, cited above, Section IX. X-Ray Screens/Phosphors, and U.S. Pat. No. 5,021,327 (Bunch et al.), U.S. Pat. No. 4,994,355 (Dickerson et al.), U.S. Pat. No. 4,997,750 (Dickerson et al.), and U.S. Pat. No. 5,108,881 (Dickerson et al.), the disclosures of which are here incorporated by reference. The fluorescent layer contains phosphor particles and a binder, optimally additionally containing a light scattering material, such as titania or light absorbing materials such as particulate carbon, dyes or pigments. Any conventional binder (or mixture thereof) can be used but preferably the binder is an aliphatic polyurethane elastomer or another highly transparent elastomeric polymer.

Any conventional or useful prompt-emitting phosphor can be used, singly or in mixtures, in the intensifying screens used in the practice of this invention. For example, useful phosphors are described in numerous references relating to fluorescent intensifying screens, including but not limited to, Research Disclosure, Vol. 184, August 1979, Item 18431, Section IX, X-ray Screens/Phosphors, and U.S. Pat. No. 2,303,942 (Wynd et al.), U.S. Pat. No. 3,778,615 (Luckey), U.S. Pat. No. 4,032,471 (Luckey), U.S. Pat. No. 4,225,653 (Brixner et al.), U.S. Pat. No. 3,418,246 (Royce), U.S. Pat. No. 3,428,247 (Yocon), U.S. Pat. No. 3,725,704 (Buchanan et al.), U.S. Pat. No. 2,725,704 (Swindells), U.S. Pat. No. 3,617,743 (Rabatin), U.S. Pat. No. 3,974,389 (Ferri et al.), U.S. Pat. No. 3,591,516 (Rabatin), U.S. Pat. No. 3,607,770 (Rabatin), U.S. Pat. No. 3,666,676 (Rabatin), U.S. Pat. No. 3,795,814 (Rabatin), U.S. Pat. No. 4,405,691 (Yale), U.S. Pat. No. 4,311,487 (Luckey et al.), U.S. Pat. No. 4,387,141 (Patten), U.S. Pat. No. 5,021,327 (Bunch et al.), U.S. Pat. No. 4,865,944 (Roberts et al.), U.S. Pat. No. 4,994,355 (Dickerson et al.), U.S. Pat. No. 4,997,750 (Dickerson et al.), U.S. Pat. No. 5,064,729 (Zegarski), U.S. Pat. No. 5,108,881 (Dickerson et al.), U.S. Pat. No. 5,250,366 (Nakajima et al.), U.S. Pat. No. 5,871,892 (Dickerson et al.), EP 0 491,116A1 (Benzo et al.), the disclosures of all of which are incorporated herein by reference with respect to the phosphors.

Useful classes of phosphors include, but are not limited to, calcium tungstate (CaWO₄), activated or unactivated lithium stannates, niobium and/or rare earth activated or unactivated yttrium, lutetium, or gadolinium tantalates, rare earth (such as terbium, lanthanum, gadolinium, cerium, and lutetium)-activated or unactivated middle chalcogen phosphors such as rare earth oxychalcogenides and oxyhalides, and terbium-activated or unactivated lanthanum and lutetium middle chalcogen phosphors.

Still other useful phosphors are those containing hafnium as described for example in U.S. Pat. No. 4,988,880 (Bryan et al.), U.S. Pat. No. 4,988,881 (Bryan et al.), U.S. Pat. No. 4,994,205 (Bryan et al.), U.S. Pat. No. 5,095,218 (Bryan et al.), U.S. Pat. No. 5,112,700 (Lambert et al.), U.S. Pat. No. 5,124,072 (Dole et al.), and U.S. Pat. No. 5,336,893 (Smith et al.), the disclosures of which are all incorporated herein by reference.

Some preferred rare earth oxychalcogenide and oxyhalide phosphors are represented by the following formula (1):

M′_{(w-n)}M″ₙO_{w}X′ (1)

wherein M′ is at least one of the metals yttrium (Y), lanthanum (La), gadolinium (Gd), or lutetium (Lu), M″ is at least one of the rare earth metals, preferably dysprosium (Dy), erbium (Er), europium (Eu), holmium (Ho), neodymium (Nd), praseodymium (Pr), samarium (Sm), tantalum (Ta), terbium (Th), thulium (Tm), or ytterbium (Yb), X′ is a middle chalcogen (S, Se, or Te) or halogen, n is 0.002 to 0.2, and w is 1 when X′ is halogen or 2 when X′ is a middle chalcogen. These include rare earth-activated lanthanum oxybromides, and terbium-activated or thulium-activated gadolinium oxides such as Gd₂O₂S:Tb.

Other suitable phosphors are described in U.S. Pat. No. 4,835,397 (Arakawa et al.) and U.S. Pat. No. 5,381,015 (Dooms), both incorporated herein by reference, and including for example divalent europium and other rare earth activated alkaline earth metal halide phosphors and rare earth element activated rare earth oxyhalide phosphors. Of these types of phosphors, the more preferred phosphors include alkaline earth metal fluorohalide prompt emitting phosphors.

Another class of useful phosphors includes rare earth hosts such as rare earth activated mixed alkaline earth metal sulfates such as europium-activated barium strontium sulfate.

Particularly useful phosphors are those containing doped or undoped tantalum such as YTaO₄, YTaO₄:Nb, Y(Sr)TaO₄, and Y(Sr)TaO₄:Nb. These phosphors are described in U.S. Pat. No. 4,226,653 (Brixner), U.S. Pat. No. 5,064,729 (Zegarski), U.S. Pat. No. 5,250,366 (Nakajima et al.), and U.S. Pat. No. 5,626,957 (Benso et al.), all incorporated herein by reference.

The fluorescent intensifying screens useful in this invention generally exhibit photographic speeds of at least 100. The preferred phosphor is a gadolinium oxysulfide:terbium (that is, terbium activated gadolinium oxysulfide). Moreover, the particle size distribution of the phosphor particles is an important factor in determining the speed and sharpness of the screen. For example, at least 50% of the particles have a size of less than 3 μm and 85% of the particles have a size of less than 5.5 μm. In addition, the coverage of phosphor in the dried layer is from about 250 to about 450 g/m², and preferably from about 300 to about 400 g/m².

Flexible support materials for radiographic screens in accordance with the present invention include cardboard, plastic films such as films of cellulose acetate, polyvinyl chloride, polyvinyl acetate, polyacrylonitrile, polystyrene, polyester, polyethylene terephthalate, polyamide, polyimide, cellulose triacetate and polycarbonate, metal sheets such as aluminum foil and aluminum alloy foil, ordinary papers, baryta paper, resin-coated papers, pigmented papers containing titanium dioxide or the like, and papers sized with polyvinyl alcohol or the like. A plastic film is preferably employed as the support material.

The plastic film may contain a light-absorbing material such as carbon black, or may contain a light-reflecting material such as titanium dioxide or barium sulfate. The former is appropriate for preparing a high-resolution type radiographic screen, while the latter is appropriate for preparing a high-sensitivity type radiographic screen. For use in this invention it is highly preferred that the support absorb substantially all of the radiation emitted by the phosphor. Examples of particularly preferred supports include polyethylene terephthalate, blue colored or black colored (for example, LUMIRROR C, type X30 supplied by Toray Industries, Tokyo, Japan).

These supports may have thicknesses that may differ depending o the material of the support, and may generally be between 60 and 1000 μm, more preferably between 80 and 500 μm from the standpoint of handling.

An essential component of the fluorescent intensifying screens useful in the practice of this invention is a protective overcoat layer disposed over the phosphor layer that includes a miscible blend of “first” and “second” polymers. This miscible blend can include two or more of each type of polymer.

The first polymer is a poly(vinylidene fluoride-co-tetrafluoroethylene) wherein the recurring units derived from the vinylidene fluoride monomer can compose from about 20 to about 80 mol % (preferably from about 40 to about 60 mol %) of the total recurring units in the polymer, and the remainder of the recurring units are derived from tetrafluoroethylene. These polymers are sometimes identified in the literature as “PVF₂” and can be prepared using known monomeric reactants and polymerization conditions. Alternatively, they can be commercially obtained from a number of sources. For example, PVF₂ is available as Kynar 7201 from Atofina Chemicals, Inc. (Philadelphia, Pa.).

The second polymer is a poly(alkyl acrylate or methacrylate). Examples of such polymers include, but are not limited to, poly(methyl acrylate), poly(methyl methacrylate), poly(ethyl acrylate), poly(ethyl methacrylate), and poly(chloromethyl methacrylate). The poly(1- or 2-carbon alkyl acrylates or methacrylates) including, but not limited to, poly(methyl methacrylate) and poly(ethyl methacrylate) are preferred. These polymers are readily prepared using known monomeric reactants and polymerization conditions, and can also be obtained from several commercial sources. For example, poly(methyl methacrylate) or “PMMA” can be obtained as Elvacite 2051 from ICI Acrylics (Memphis, Tenn.).

The miscible blends of the first and second polymers can be readily prepared by dissolving the two polymers in a suitable solvent (for example, methyl ethyl ketone). Details of some blends of such polymers are provided in Paul et al., “Polymer Blends”, Concise Encyclopedia of Polymer Science and Engineering, Kroschwitz, Ed., John Wiley & Sons, New York (1990), pp. 830-835. Generally, the weight ratio of the first polymer to the second polymer is from about 70:30 to about 10:90, and preferably, this weight ratio is from about 70:30 to about 50:50.

While the miscible blend of polymers comprises most of the protective overcoat layer weight (at least 90 weight % of total dry weight), the layer can also include various matte particles, lubricants, micronized waxes, and surfactants, if desired.

Useful matte particles include both inorganic and organic particles that generally have a particle size of from about 4 to about 20 μm. Examples of suitable matte particles include, but are not limited to, talc, silica particles or other inorganic particulate materials, and various organic polymeric particles that are known for this purpose in the art. The amount of matte particles present in the protective overcoat layer can be up to 10% (based on total layer dry weight).

The protective overcoat layer may also include one or more lubricants in an amount of up to 10% (based on total dry layer weight). Useful lubricants can be either in solid or liquid form and include such materials as surface active agents, silicone oils, synthetic oils, polysiloxane-polyether copolymers, polyolefin-polyether block copolymers, fluorinated polymers, polyolefins, and what are known as micronized waxes (which are preferred).

The protective overcoat layer generally has a dry thickness of from about 3 to about 15 μm, and a preferred dry thickness of from about 4 to about 8 μm.

Preferred embodiments of this invention include a radiographic imaging assembly comprising:

A) a radiographic silver halide film as described herein, and

B) a single fluorescent intensifying screen that has a photographic speed of at least 100 and comprises a gadolinium oxysulfide:terbium phosphor capable of absorbing X-rays and emitting electromagnetic radiation having a wavelength greater than 300 nm, the phosphor being coated in admixture with a polymeric binder in a phosphor layer onto a flexible polymeric support and having a protective overcoat disposed over the phosphor layer,

wherein the phosphor is present as particles wherein at least 50% of the particles have a size of less than 3 μm and at least 85% of the particles have a size of less than 5.5 μm, and the coverage of the phosphor in the phosphor layer is from about 300 to about 400 g/m², and

wherein the protective overcoat layer has a dry thickness of from about 4 to about 8 μm, and comprises poly(vinylidene fluoride-co-tetrafluoroethylene and poly(1, or 2-carbon alkyl acrylate or methacrylate) in a weight ratio of from about 70:30 to about 50:50, wherein the two polymers comprise at least 90% of the dry layer weight, and the protective overcoat layer also comprises matte particles and a micronized wax.

Imaging and Processing:

Exposure and processing of the radiographic silver halide films can be undertaken in any convenient conventional manner. The exposure and processing techniques of U.S. Pat. No. 5,021,327 and U.S. Pat. No. 5,576,156 (both noted above) are typical for processing radiographic films. Other processing compositions (both developing and fixing compositions) are described in U.S. Pat. No. 5,738,979 (Fitterman et al.), U.S. Pat. No. 5,866,309 (Fitterman et al.), U.S. Pat. No. 5,871,890 (Fitterman et al.), U.S. Pat. No. 5,935,770 (Fitterman et al.), U.S. Pat. No. 5,942,378 (Fitterman et al.), all incorporated herein by reference. The processing compositions can be supplied as single- or multi-part formulations, and in concentrated form or as more diluted working strength solutions.

Exposing X-radiation is generally directed through the fluorescent intensifying screen before it passes through the radiographic silver halide film for imaging soft tissue such as breast tissue.

It is particularly desirable that the radiographic silver halide films be processed within 90 seconds (“dry-to-dry”) and preferably within 45 seconds and at least 20 seconds, for the developing, fixing and any washing (or rinsing) steps. Such processing can be carried out in any suitable processing equipment including but not limited to, a Kodak X-OMAT® RA 480 processor that can utilize Kodak Rapid Access processing chemistry. Other “rapid access processors” are described for example in U.S. Pat. No. 3,545,971 (Barnes et al.) and EP 0 248,390A1 (Akio et al.). Preferably, the black-and-white developing compositions used during processing are free of any gelatin hardeners, such as glutaraldehyde.

Since rapid access processors employed in the industry vary in their specific processing cycles and selections of processing compositions, the preferred radiographic films satisfying the requirements of the present invention are specifically identified as those that are capable of dry-to-dye processing according to the following reference conditions:

| | |
|---|---|
| Development | 11.1 seconds at 35° C., |
| Fixing | 9.4 seconds at 35° C., |
| Washing | 7.6 seconds at 35° C., |
| Drying | 12.2 seconds at 55-65° C. |

Any additional time is taken up in transport between processing steps. Typical black-and-white developing and fixing compositions are described in the Example below.

Radiographic kits can include a radiographic imaging assembly of this invention, one or more additional fluorescent intensifying screens and/or metal screens, and/or one or more suitable processing compositions (for example black-and-white developing and fixing compositions).

The following example is presented for illustration and the invention is not to be interpreted as limited thereby.

### EXAMPLE

A radiographic imaging assembly of the present invention was prepared by combining the following radiographic silver halide film with the fluorescent intensifying screen A noted below in a suitable cassette.

Radiographic Film:

Radiographic Film B was a dual-coated radiographic film with ⅔ of the silver and gelatin coated on one side of the support and the remainder coated on the opposite side of the support. It also included a halation control layer containing solid particle dyes to provide improved sharpness. The film contained a green-sensitive, high aspect ratio tabular silver bromide grain emulsion on both sides of the support. Thus, at least 50% of the total grain projected area is accounted for by tabular grains having a thickness of less than 0.3 μm and having an average aspect ratio greater than 8:1. The emulsion average grain diameter was 2.0 μm and the average grain thickness was 0.10 μm. It was polydisperse in distribution and had a coefficient of variation of 38. The emulsion was spectrally sensitized with anhydro-5,5-dichloro-9-ethyl-3,3′-bis(3-sulfopropyl)oxa-carbocyanine hydroxide (680 mg/Ag mole), followed by potassium iodide (300 mg/Ag mole). Film B had the following layer arrangement and formulations on the film support:

Overcoat 1

Interlayer

Emulsion Layer 1

Support

Emulsion Layer 2

Halation Control Layer

Overcoat 2

| | Coverage (mg/dm²) |
|---|---|
| Overcoat 1 Formulation | |
| Gelatin vehicle | 4.4 |
| Methyl methacrylate matte beads | 0.35 |
| Carboxymethyl casein | 0.73 |
| Colloidal silica (LUDOX AM) | 1.1 |
| Polyacrylamide | 0.85 |
| Chrome alum | 0.032 |
| Resorcinol | 0.73 |
| Dow Corning Silicone | 0.153 |
| TRITON ® X-200 surfactant | 0.26 |
| LODYNE S-100 surfactant | 0.0097 |
| Interlayer Formulation | |
| Gelatin vehicle | 4.4 |
| Emulsion Layer 1 Formulation | |
| Cubic grain emulsion | 40.3 |
| [AgIClBr (0.5:15:84.5 halide mole ratio)] | |
| Gelatin vehicle | 21.6 |
| Dextran | 8 |
| 4-Hydroxy-6-methyl-1,3,3a,7- | 1 g/Ag mole |
| tetraazaindene | |
| 1-(3-Acetamidophenyl)-5-mercaptotetrazole | 0.026 |
| Maleic acid hydrazide | 0.0076 |
| Catechol disulfonate | 0.2 |
| Glycerin | 0.22 |
| Potassium bromide | 0.13 |
| Resorcinol | 2.12 |
| Bisvinylsulfonylmethane | 0.8% based on |
| | total gelatin in all |
| | layers on each side |
| Emulsion Layer 2 Formulation | |
| Tabular grain emulsion | 10.8 |
| [AgBr 2.0 × 0.10 μm average size] | |
| Gelatin vehicle | 16.1 |
| 4-Hydroxy-6-methyl-1,3,3a,7- | 2.1 g/Ag mole |
| tetraazaindene | |
| 1-(3-Acetamidophenyl)-5-mercaptotetrazole | 0.013 |
| Maleic acid hydrazide | 0.0032 |
| Catechol disulfonate | 0.2 |
| Glycerin | 0.11 |
| Potassium bromide | 0.06 |
| Resorcinol | 1.0 |
| Bisvinylsulfonylmethane | 2% based on |
| | total gelatin in |
| | all layers on |
| | each side |
| Halation Control Layer | |
| Magenta filter dye M-1 (noted above) | 2.2 |
| Gelatin | 10.8 |
| Overcoat 2 Formulation | |
| Gelatin vehicle | 8.8 |
| Methyl methacrylate matte beads | 0.14 |
| Carboxymethyl casein | 1.25 |
| Colloidal silica (LUDOX AM) | 2.19 |
| Polyacrylamide | 1.71 |
| Chrome alum | 0.066 |
| Resorcinol | 0.15 |
| Dow Corning Silicone | 0.16 |
| TRITON ® X-200 surfactant | 0.26 |
| LODYNE S-100 surfactant | 0.01 |

| Interlayer | Coverage |
|---|---|
| Formulation | (mg/dm²) |
| Gelatin vehicle | 4.4 |

| Emulsion Layer 1 | Coverage |
|---|---|
| Formulation | (mg/dm²) |
| Cubic grain emulsion | 40.3 |
| [AgIClBr (0.5:15:84.5 halide mole ratio)] | |
| Gelatin vehicle | 21.6 |
| Dextran | 8 |
| 4-Hydroxy-6-methyl-1,3,3a,7- | 1 g/Ag mole |
| tetraazaindene | |
| 1-(3-Acetamidophenyl)-5-mercaptotetrazole | 0.026 |
| Maleic acid hydrazide | 0.0076 |
| Catechol disulfonate | 0.2 |
| Glycerin | 0.22 |
| Potassium bromide | 0.13 |
| Resorcinol | 2.12 |
| Bisvinylsulfonylmethane | 0.8 % based on |
| | total gelatin in all |
| | layers on each side |

| Emulsion Layer 2 | Coverage |
|---|---|
| Formulation | (mg/dm²) |
| Tabular grain emulsion | 10.8 |
| [AgBr 2.0 × 0.10 μm average size] | |
| Gelatin vehicle | 16.1 |
| 4-Hydroxy-6-methyl-1,3,3a,7- | 2.1 g/Ag mole |
| tetraazaindene | |
| 1-(3-Acetamidophenyl)-5-mercaptotetrazole | 0.013 |
| Maleic acid hydrazide | 0.0032 |
| Catechol disulfonate | 0.2 |
| Glycerin | 0.11 |
| Potassium bromide | 0.06 |
| Resorcinol | 1.0 |
| Bisvinylsulfonylmethane | 2% based on |
| | total gelatin in |
| | all layers on |
| | each side |

| Halation | Coverage |
|---|---|
| Control Layer | (mg/dm²) |
| Magenta filter dye | 2.2 |
| M-1 (noted above) | |
| Gelatin | 10.8 |

| Overcoat 2 | Coverage |
|---|---|
| Formulation | (mg/dm²) |
| Gelatin vehicle | 8.8 |
| Methyl methacrylate matte beads | 0.14 |
| Carboxymethyl casein | 1.25 |
| Colloidal silica (LUDOX AM) | 2.19 |
| Polyacrylamide | 1.71 |
| Chrome alum | 0.066 |
| Resorcinol | 0.15 |
| Dow Corning Silicone | 0.16 |
| TRITON ® X-200 surfactant | 0.26 |
| LODYNE S-100 surfactant | 0.01 |

The AgIClBr cubic grains in Emulsion Layer 1 were chemically sensitized with sulfur and gold and spectrally sensitized with a 1:1 molar ratio of dyes A-2 and B-1 (noted below). The emulsion was doped with ruthenium hexacyanide (50 mg/Ag mole).

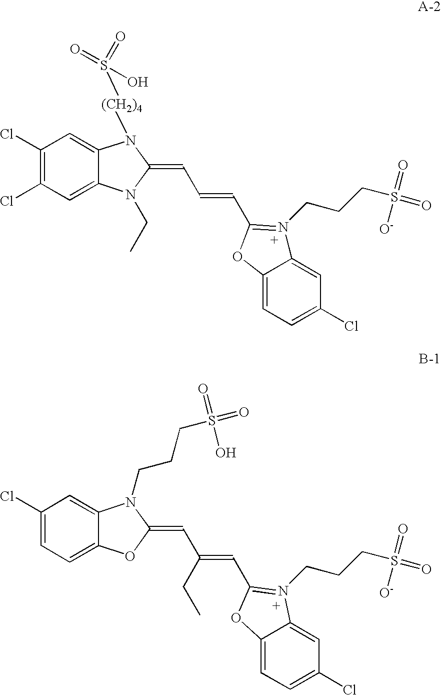

The cassettes used in the practice of this invention were those commonly used in mammography.

Fluorescent Intensifying Screen A (Invention):

The fluorescent intensifying screen used in the practice of this invention contained a terbium activated gadolinium oxysulfide phosphor (median particle size of about 3.0 μm) dispersed in a Permuthane™ polyurethane binder on a blue-tinted poly(ethylene terephthalate) film support. The total phosphor coverage was 330 g/m² and the phosphor to binder weight ratio was 29:1.

Over the phosphor layer was disposed a protective overcoat layer comprising a polymer blend of poly(methyl methacrylate) (Elvacite 2051, ICI Acrylics) and poly (vinylidene fluoride-co-chlorotrifluoroethylene) (Kynar 7210, Atofina Chemicals Inc) with the two polymers blended in a 1:1 ratio, crosslinked, styrenic polymer matte beads (50% PSD=12 μm) added at 3% by weight of the binder polymers, and a micronized polyethylene wax (Superslip 6530, Micropowders Inc.) added at 3% by weight of the binder polymers. The polymer solution was prepared in methylethyl ketone and coated on top of the phosphor layer to give a dry coverage of about 5.4 g/m² (˜6 micron dry thickness).

Fluorescent Intensifying Screen B (Control):

A fluorescent intensifying screen outside of the present invention was prepared in the same manner as Screen A except that the protective overcoat layer comprised 14 μm polymeric matte beads in cellulose acetate (dry thickness of 6 μm).

A single screen (A or B) was placed in back of the film to form a radiographic imaging assemblies useful for mammography.

The films in the radiographic imaging assemblies were exposed through a graduated density step tablet to a MacBeth sensitometer for 0.5 second to a 500-watt General Electric DMX projector lamp that was calibrated to 2650° K. filtered with a Coming C4010 filter to simulate a green-emitting X-ray screen exposure. The film were processed using a processor commercially available under the trademark KODAK RP X-OMAT® film Processor M6A-N, M6B, or M35A. Development was carried out using the following black-and-white developing composition:

| | |
|---|---|
| Hydroquinone | 30 g |
| Phenidone | 1.5 g |
| Potassium hydroxide | 21 g |
| NaHCO₃ | 7.5 g |
| K₂SO₃ | 44.2 g |
| Na₂S₂O₅ | 12.6 g |
| Sodium bromide | 35 g |
| 5-Methylbenzotriazole | 0.06 g |
| Glutaraldehyde | 4.9 g |
| Water to 1 liter, pH 10 | |

The film were processed for less than 90 seconds. Fixing was carried out using KODAK RP X-OMAT® LO Fixer and Replenisher fixing composition (Eastman Kodak Company).

The properties of each screen were evaluated in the following manner to determine the advantages or disadvantages of each protective overcoat layer.

a) Stain Resistance:

0.5 ml of distilled water was placed on the surface of the Control Screen B and the screen then placed in contact with a sheet of Kodak MinR2000® film with the emulsion side of the film placed against the screen such that the water was contained between the film and the screen. A similar sandwich assembly was prepared using the Screen A of the invention. The film-screen assemblies were left in contact for a period of 48 hours and then separated. The screens were washed with screen cleaner, air dried, placed into a vacuum cassette, and exposed to 28 kVp X-radiation to make uniform density radiographs with a density of 1.0. Density differences between the area where the screen had been covered with water and the rest of the screen were then measured.

| | Density Difference |
|---|---|
| Control Screen B | 0.18-0.2 |
| Invention Screen A | 0.0 |

b) Abrasion Resistance:

Samples of the Control Screen B and the Invention Screen A were placed phosphor side up on a smooth, hard surface. The surface of the screen was a braided 10 times with a path length of 6-8 inches (15.2-20.3 cm) using a thumbnail under moderate pressure. After abrasion, the thumbnail and fingertip were examined for the presence of white powder (indicating that the matte particles had been removed from the overcoat), and the screen was held up to a bright light source at a 45 degree angle and examined for the presence of scratches and abrasions. Abrasion of the Control Screen B resulted in the presence of a small amount of white powder on the thumbnail indicating removal of matte. When examined under the light, gloss streaks resulting for removal of matte and smoothing of the polymer surface were easily visible. In addition, fine scratches were present in the surface of the overcoat. In contrast, no white matte powder was present on the film used to scratch the overcoat of Invention Screen A indicating that the matte was still in place. In addition, examination of the overcoat of Invention Screen A under the inspection light, showed no presence of gloss streaks and no find scratches in the surface of the overcoat.

c) Air purge:

Both the control and invention screens were cut to size, laminated to identical foam backings and installed into conventional Kodak MinR-2® mammographic cassettes. Sheets of film were placed into the cassettes and film-screen contact measured using a wire mesh technique described in International Standard IEC 61223-2-10 Evaluation and Routine Testing in Medical Imaging Departments, part 2-10: Constancy Tests-X-ray Equipment for Mammography, section 5.4.2.2. Contact radiographs were prepared one minute, three minutes, and five minutes after the film was loaded into the cassette.

Both control and invention screens showed excellent film screen contact at each of the intervals.

The testing of the control screens and screens of the invention showed that the screens of the invention exhibited superior resistance to staining and resistance to abrasion while excellent film-screen contact was maintained.

The invention has been described in detail with particular reference to preferred embodiments thereof, but it will be understood that variations and modifications can be effected within the spirit and scope of the invention.

We claim:

1. A radiographic imaging assembly comprising:
A) a single radiographic silver halide film comprising a support having first and second major surfaces and that is capable of transmitting X-radiation,
said radiographic silver halide film having disposed on the first major support surface, one or more hydrophilic colloid layers including at least one silver halide emulsion layer, and on the second major support surface, one or more hydrophilic colloid layers including at least one silver halide emulsion layer,
at least one of said silver halide emulsion layers comprising cubic silver halide grains that have the same or different composition, and
B) a single fluorescent intensifying screen that comprises an inorganic phosphor capable of absorbing X-rays and emitting electromagnetic radiation having a wavelength greater than 300 nm, said inorganic phosphor being coated in admixture with a polymeric binder in a phosphor layer onto a flexible support and having a protective overcoat layer disposed over said phosphor layer,
said protective overcoat layer comprising a miscible blend of a first polymer that is poly(vinylidene fluoride-co-tetrafluoroethylene) and a second polymer that is a poly(alkyl acrylate or methacrylate).

2. The radiographic imaging assembly of claim 1 wherein said protective overcoat layer further comprises matte particles.

3. The radiographic imaging assembly of claim 3 wherein said protective overcoat layer further comprises a solid micronized wax.

4. The radiographic imaging assembly of claim 1 wherein the weight ratio of said first polymer to said second polymer is from about 70:30 to about 10:90.

5. The radiographic imaging assembly of claim 4 wherein the weight ratio of said first polymer to said second polymer is from about 70:30 to about 50:50.

6. The radiographic imaging assembly of claim 1 wherein said second polymer is a poly( 1 or 2 carbon alkyl acrylate or methacrylate).

7. The radiographic imaging assembly of claim 6 wherein said second polymer is poly(methyl methacrylate) or poly(ethyl methacrylate).

8. The radiographic imaging assembly of claim 1 wherein said protective overcoat layer has a dry thickness of from about 3 to about 15 μm.

9. The radiographic imaging assembly of claim 1 wherein said first and second polymer comprise at least 90 weight % of the total protective overcoat layer dry weight.

10. The radiographic imaging assembly of claim 1 wherein said radiographic silver halide film comprises a cubic silver halide grain emulsion layer on said first support surface and a tabular silver halide grain emulsion layer on said second support surface.

11. The radiographic imaging assembly of claim 1 wherein said radiographic silver halide film further comprises an antihalation layer disposed on said second major support surface.

12. The radiographic imaging assembly of claim 1 wherein said inorganic phosphor is calcium tungstate, activated or unactivated lithium stannates, niobium and/or rare earth activated or unactivated yttrium, lutetium, or gadolinium tantalates, rare earth-activated or unactivated middle chalcogen phosphors such as rare earth oxychalcogenides and oxyhalides, or terbium-activated or unactivated lanthanum or lutetium middle chalcogen phosphor.

13. The radiographic imaging assembly of claim 1 wherein said cubic grain silver halide emulsion layer comprises:
1) a combination of first and second spectral sensitizing dyes that provides a combined maximum J-aggregate absorption on said cubic silver halide grains of from about 540 to about 560 nm, and
wherein said first spectral sensitizing dye is an anionic benzimidazole-benzoxazole carbocyanine, said second spectral sensitizing dye is an anionic oxycarbocyanine, and said first and second spectral sensitizing dyes are present in a molar ratio of from about 0.25:1 to about 4:1,
2) a mixture of a first hydrophilic binder that is gelatin or a gelatin derivative and a second hydrophilic binder other than gelatin or a gelatin derivative, wherein the weight ratio of said first hydrophilic binder to said second hydrophilic binder is from about 2:1 to about 5:1, and the level of hardener in said cubic grain silver halide emulsion layer is from about 0.4 to about 1.5 weight % based on the total weight of said first hydrophilic binder in said cubic grain silver halide emulsion layer,
3) cubic silver halide grains comprising from about 1 to about 20 mol % chloride and from about 0.25 to about 1.5 mol % iodide, both based on total silver in said cubic grain emulsion layer, which cubic silver halide grains have an average ECD of from about 0.65 to about 0.8 μm, and
4) cubic silver halide grains that are doped with a hexacoordination complex compound within part or all of 95% of the innermost volume from the center of said cubic silver halide grains.

14. The radiographic imaging assembly of claim 1 wherein said single fluorescent intensifying screen comprises a gadolinium oxysulfide:terbium phosphor that is present as particles wherein at least 50% of the particles have a size of less than 3 μm and at least 85% of the particles have a size of less than 5.5 μm, and the coverage of said phosphor in said phosphor layer is from about 300 to about 400 g/m².

15. A method of providing a black-and-white image comprising exposing the radiographic imaging assembly of claim 1, and processing said radiographic silver halide film, sequentially, with a black-and-white developing composition and a fixing composition, said processing being carried out within 90 seconds, dry-to-dry.

16. The method of claim 15 wherein said black-and-white developing composition is free of any photographic film hardeners.

17. The method of claim 15 that is used to provide a medical diagnosis.

18. The method of claim 15 that is carried out within 60 seconds, dry-to-dry.

19. A method of imaging for mammography comprising exposing a patient to X-radiation using an X-radiation generating device comprising rhodium or tungsten anodes, and providing a black-and-white image of said exposed patient using an imaging assembly comprising:
A) a single radiographic silver halide film comprising a support having first and second major surfaces and that is capable of transmitting X-radiation,
said radiographic silver halide film having disposed on the first major support surface, one or more hydrophilic colloid layers including at least one silver halide emulsion layer, and on the second major support surface, one or more hydrophilic colloid layers including at least one silver halide emulsion layer,
at least one of said silver halide emulsion layers comprising cubic silver halide grains that have the same or different composition in each silver halide emulsion layer, and
B) a single fluorescent intensifying screen that has a photographic speed of at least 100 and comprises an inorganic phosphor capable of absorbing X-rays and emitting electromagnetic radiation having a wavelength greater than 300 nm, said inorganic phosphor being coated in admixture with a polymeric binder in a phosphor layer onto a flexible support and having a protective overcoat layer disposed over said phosphor layer,
said protective overcoat layer comprising a miscible blend of a first polymer that is poly(vinylidene fluoride-co-tetrafluoroethylene) and a second polymer that is a poly(alkyl acrylate or methacrylate).
